(19) United States
(12) Patent Application Publication
(10) Pub. No.: US 2015/0277273 A1
(43) Pub. Date: Oct. 1, 2015

(54) ELECTROSTATIC CHARGE IMAGE DEVELOPING CARRIER, ELECTROSTATIC CHARGE IMAGE DEVELOPER, AND DEVELOPER CARTRIDGE

(71) Applicant: FUJI XEROX CO., LTD., Tokyo (JP)

(72) Inventors: Takeshi SHOJI, Kanagawa (JP); Yosuke TSURUMI, Kanagawa (JP)

(21) Appl. No.: 14/590,430

(22) Filed: Jan. 6, 2015

(30) Foreign Application Priority Data
Mar. 25, 2014 (JP) 2014-062452

(51) Int. Cl. G03G 9/00

(52) U.S. Cl. CPC G03G 15/0808

(57) ABSTRACT

An electrostatic charge image developing carrier includes core particles, a coating layer that covers the core particles, and inorganic particles that are adhered to the surface of the coating layer, wherein the inorganic particles have a volume average particle diameter in a range of 150 nm to 500 nm, and an adhesion amount in a range of 0.02% by weight to 0.1% by weight with respect to the entire carrier.

### CROSS-REFERENCE TO RELATED APPLICATIONS

This application is based on and claims priority under 35 USC 119 from Japanese Patent Application No. 2014-062452 filed Mar. 25, 2014.

### BACKGROUND

1. Technical Field

The present invention relates to an electrostatic charge image developing carrier, an electrostatic charge image developer, and a developer cartridge.

2. Related Art

In the related art, a method of forming an electrostatic charge image on a latent image holding member (photoreceptor) or an electrostatic recording member using various techniques and developing an electrostatic charge image by adhering electroscopic particles referred to as a toner thereto is used as an electrophotographic method. In the development of the electrostatic charge image, a toner and a carrier are mixed with each other, frictionally charged, and are used after applying a positive or negative charge to the toner. The carrier is roughly classified into a coated carrier generally having a coating layer on a surface and a non-coated carrier without a coating layer. Between these two, the coated carrier is excellent in consideration of the service life of a developer.

### SUMMARY

According to an aspect of the invention, there is provided an electrostatic charge image developing carrier, including:

core particles;

a coating layer that covers the core particles; and

inorganic particles that are adhered to the surface of the coating layer, wherein the inorganic particles have a volume average particle diameter in a range of 150 nm to 500 nm, and an adhesion amount in a range of 0.02% by weight to 0.1% by weight with respect to the entire carrier.

### BRIEF DESCRIPTION OF THE DRAWINGS

Exemplary embodiments of the present invention will be described in detail based on the following figures, wherein:

FIG. 1 is a view schematically illustrating an example of a configuration of an image forming apparatus according to an exemplary embodiment; and

FIG. 2 is a view schematically illustrating an example of a configuration of an image forming apparatus according to another exemplary embodiment.

### DETAILED DESCRIPTION

Hereinafter, exemplary embodiments which are examples of the present invention will be described in detail.

Electrostatic Charge Image Developing Carrier

An electrostatic charge image developing carrier of the present exemplary embodiment (hereinafter, referred to as a “carrier”) includes core particles, a coating layer covering the core particles, and inorganic particles adhered to the surface of the coating layer.

Further, the volume average particle diameter of the inorganic particles is in the range of 150 nm to 500 nm and the adhesion amount thereof is in the range of 0.02% by weight to 0.1% by weight with respect to the entire carrier.

Here, in an electrophotographic system, an image is formed by charging a toner of a developer including the toner and a carrier. Frictional charging between the toner and the carrier is used for charging the toner. However, when a mechanical load is applied to the developer by stirring or the like in a developing unit, a phenomenon in which an external additive isolated from a toner is moved to a carrier and adheres to a coating layer of the carrier occurs in some cases. Particularly, when images with high image density are continuously output, the phenomenon in which an external additive of a toner is adhered to a coating layer of a carrier prominently occurs because the mechanical load applied to the developer is increased.

When the phenomenon in which an external additive of a toner is adhered to a coating layer of a carrier occurs, the original charge imparting ability of a carrier with respect to a toner is changed so that the charging amount of the toner is decreased. Consequently, thin line reproducibility of an image becomes deteriorated.

In the carrier according to the present exemplary embodiment, the inorganic particles having a volume average particle diameter of 150 nm to 500 nm are adhered to the coating layer with an adhesion amount in the range of 0.02% by weight to 0.1% by weight with respect to the entire carrier. Since the inorganic particles are large diameter particles, a buffer function (spacer function) is exerted between the coating layer of the carrier and the external additive isolated from the toner and therefore it is assumed that it is difficult for the external additive of the toner to be adhered to the coating layer of the carrier even when a mechanical load is applied to the developer.

Accordingly, the carrier of the present exemplary embodiment prevents deterioration of the thin line reproducibility of an image. Particularly, even when images with high image density are continuously output, deterioration of the thin line reproducibility of an image is prevented.

Further, in the related art, a technique of adhering inorganic particles to a coating layer of a carrier is also known. However, since the inorganic particles are small diameter particles having a particle diameter of 10 nm to 100 nm, it is difficult for a buffer function (spacer function) to be exerted between the coating layer of the carrier and the external additive isolated from the toner.

Hereinafter, the carrier according to the present exemplary embodiment will be described in detail.

Specifically, the carrier of the present exemplary embodiment is a carrier in which inorganic particles are adhered to the surface of a carrier substance including core particles and a coating layer that covers the core particles.

—Core Particles—

Examples of the core particles include magnetic metal particles (for example, particles of iron, nickel, or cobalt), magnetic oxide particles (for example, particles of ferrite or magnetite), and dispersion type resin particles in which these particles are dispersed in a resin. Further, as the core particles, particles obtained by impregnating porous magnetic particle with a resin may be exemplified.

It is preferable that the core particles be ferrite particles represented by the following formula.

(MO)_{X}(Fe₂O₃)_{Y} Formula

In the formula, Y is in a range of 2.1 to 2.4 and X represents 3−Y. M represents a metallic element and may preferably contain at least Mn as the metallic element.

M mainly includes Mn, but at least one kind selected from the group consisting of Li, Ca, Sr, Sn, Cu, Zn, Ba, Mg, and Ti (preferably, a group consisting of Li, Ca, Sr, Mg, and Ti in terms of the environment) may be combined together.

The core particles may be obtained by magnetic granulation and sintering, and a magnetic material may be pulverized as a pre-treatment. A pulverizing method is not particularly limited, and specific examples thereof include known pulverizing methods such as a mortar, a ball mill, and a jet mill.

Here, the resin included in the dispersion type resin particles or the like as the core particles is not particularly limited, and examples thereof include a styrene resin, an acrylic resin, a phenol resin, a melamine resin, an epoxy resin, a urethane resin, a polyester resin, and a silicone resin. Further, other components such as a charge-controlling agent and fluorine-containing particles may be contained in the dispersion type resin particles as the core particles according to the purpose.

The volume average particle diameter of the core particles may be in the range of 10 μm to 500 μm, preferably in the range of 20 μm to 100 μm, and more preferably in the range of 25 μm to 60 μm.

—Coating Layer—

The coating layer contains a coating resin. Examples of the coating resin include an acrylic resin, a polyethylene resin, a polypropylene resin, a polystyrene resin, a polyacrylonitrile resin, a polyvinyl acetate resin, a polyvinyl alcohol resin, a polyvinyl butyral resin, a polyvinyl chloride resin, a polyvinyl carbazole resin, a polyvinyl ether resin, a polyvinyl ketone resin, a vinyl chloride-vinyl acetate copolymer, a styrene-acrylic acid copolymer, a straight silicone resin having an organosiloxane bond or a modified product thereof, a fluorine resin, a polyester resin, a polyurethane resin, a polycarbonate resin, a phenol resin, an amino resin, a melamine resin, a benzoguanamine resin, a urea resin, an amide resin, and an epoxy resin.

The coating layer may contain resin particles for the purpose of charge control and conductive particles for the purpose of resistance control. The coating layer may contain other additives.

The resin particles are not particularly limited, but particles having a charge-controllability imparting property are preferable, and examples thereof include melamine resin particles, urea resin particles, urethane resin particles, polyester resin particles, and acrylic resin particles.

Examples of conductive particles include carbon black, various metal powder, and metal oxides (for example, titanium oxide, tin oxide, magnetite, or ferrite). These may be used alone or in combination of two or more kinds thereof. Among these, in terms of excellent production stability, low cost, and excellent conductivity, carbon black particles are preferable. The kind of carbon black is not particularly limited, but carbon black whose DBP oil absorption amount is in the range of, approximately, 50 mL/100 g to 250 mL/100 g is preferable in terms of excellent preparation stability.

Examples of a method of forming the coating layer on the surface of core particles include a wet method and a dry method. The wet method is a method of using a solvent that dissolves or disperses the coating resin of the coating layer. Meanwhile, the dry method is a method without using the solvent described above.

Examples of the wet method include an immersion method of immersing core particles in a resin liquid for forming a coating layer and coating the particles with the resin liquid; a spray method of spraying a resin liquid for forming a coating layer to the surface of core particles; a fluidized bed method of spraying a resin liquid for forming a coating layer in a state in which core particles are fluidized in a fluidized bed; and a kneader coater method of mixing core particles with a resin liquid for forming a coating layer in a kneader coater and removing the solvent.

Examples of the dry method include a method of forming a coating layer by heating a mixture of core particles and a coating layer-forming material in a dry state. Specifically, the core particles and the coating layer-forming material are mixed with each other in a gas phase, and the mixture is heated and melted, thereby forming a coating layer.

The coating amount of the coating layer with respect to the core particles may be 0.5% by weight or more (preferably in the range of 0.7% by weight to 6% by weight and more preferably in the range of 1.0% by weight to 5.0% by weight) with respect to the total weight of the entire carrier.

The coating amount of the coating layer is obtained as follows.

In a case of a solvent-soluble coating layer, a precisely weighed carrier is dissolved in a soluble solvent (for example, toluene), core particles are held by a magnet, and the solution in which the coating layer is dissolved is washed away. By repeating this process several times, core particles from which the coating layer is removed remain. The coating amount of the coating layer is calculated by drying the core particles, measuring the weight of the core particles, and dividing the difference by the carrier amount.

Specifically, 20.0 g of a carrier is weighed, the weighed carrier is put into a beaker, 100 g of toluene is added thereto, and the mixture is stirred by a stirring blade for 10 minutes. A magnet is brought into contact with the bottom of the beaker and toluene is allowed to flow out such that the core particles do not flow out of the beaker. This process is repeated four times and the washed beaker is dried. A magnetic particle amount after the beaker is dried is measured and the coating amount is calculated using a formula [(carrier amount−the amount of core particles after the solution is washed)/carrier amount].

In contrast, in a case of a solvent-insoluble coating layer, the layer is heated in a temperature range of room temperature (25° C.) to 1000° C. using Thermo plus EVOII differential type differential thermal balance TG8120 (manufactured by Rigaku Corporation) under a nitrogen atmosphere and the coating amount is calculated from a decrease in weight thereof.

—Inorganic Particles—

Examples of the inorganic particles include particles such as silica, alumina, titanium oxide, barium titanate, magnesium titanate, calcium titanate, strontium titanate, iron oxide, copper oxide, zinc oxide, tin oxide, silica sand, clay, mica, wollastonite, diatomaceous earth, chromium oxide, cerium oxide, red iron oxide, antimony trioxide, magnesium oxide, zirconium oxide, barium sulfate, barium carbonate, calcium carbonate, silicon carbide, and silicon nitride. Among these, as the inorganic particles, silica particles are particularly preferable.

The surface of the inorganic particles may be subjected to a treatment with a hydrophobizing agent. A known surface treatment agent is exemplified as a hydrophobizing agent, and specific examples thereof include a silane coupling agent and silicone oil.

Examples of the silane coupling agent include hexamethyldisilazane, trimethylsilane, trimethylchlorosilane, dimethyldichlorosilane, methyltrichlorosilane, allyl dimethyl chlorosilane, benzyl dimethyl chlorosilane, methyl trimethoxy silane, methyl triethoxy silane, isobutyl trimethoxy silane, dimethyl dimethoxy silane, dimethyl diethoxy silane, trimethyl methoxy silane, hydroxy propyl trimethoxy silane, phenyl trimethoxy silane, n-butyl trimethoxysilane, n-hexadecyl trimethoxysilane, n-octadecyltrimethoxysilane, vinyltrimethoxysilane, vinyltriethoxysilane, γ-methacryloxypropyltrimethoxysilane, and vinyltriacetoxysilane.

Examples of the silicone oil include dimethyl polysiloxane, methyl hydrogen polysiloxane, and methyl phenyl polysiloxane.

The volume average particle diameter of the inorganic particles is in the range of 150 nm to 500 nm, preferably in the range of 200 nm to 400 nm, and more preferably in the range of 230 nm to 300 nm in terms of preventing deterioration of thin line reproducibility of an image.

The volume average particle diameter of the inorganic particles is measured by observing the surface of the carrier using a scanning microscope and analyzing an image of inorganic particles adhered to the coating layer. Specifically, 50 inorganic particles per carrier are observed using a scanning microscope, the longest diameter and the shortest diameter are measured for each particle by analyzing an image of the inorganic particles, and an equivalent spherical diameter is measured from the intermediate value. The equivalent spherical diameter is measured with respect to 100 carriers. Further, a 50% diameter (D50v) in the cumulative frequency of the obtained equivalent spherical diameters is set as the volume average particle diameter of the inorganic particles.

The adhesion amount of the inorganic particles (amount of the inorganic particles adhered to the coating layer) is in the range of 0.02% by weight to 0.1% by weight with respect to the entire carrier, preferably in the range of 0.03% by weight to 0.1% by weight, and more preferably in the range of 0.05% by weight to 0.09% by weight in terms of preventing deterioration of thin line reproducibility of an image.

The adhesion amount of the inorganic particles is obtained by performing quantitative analysis of X-ray fluorescence intensity. Specifically, 200 mg of a mixture of a carrier (carrier to which inorganic particles are not adhered) whose concentration is known and inorganic particles is prepared as a pellet sample using a tablet shaper for IR having a diameter of 13 mm, and the weight thereof is accurately measured, and then peak intensity is obtained by performing X-ray fluorescence measurement on the pellet sample. In the same manner, a sample whose amount of inorganic particles to be added is changed is also measured, and a calibration curve is prepared from the results thereof. The quantitative analysis of the content of a constituent element (for example, Si in a case of silica particles) of the inorganic particles in the carrier which is an actual measurement target is performed using the calibration curve. In this manner, the adhesion amount of the inorganic particles is calculated.

In addition, the X-ray fluorescence intensity is measured using an X-ray fluorescence analyzer (XRF1500, manufactured by Shimadzu Corporation) under the conditions of an X-ray output of 40 V, 70 mA, a measurement area of 10 mmφ, and 15 minutes of measurement time. Further, in a case where a peak derived from the constituent element of the inorganic particles as a measurement target is overlapped with a peak of another element, the intensity of the constituent element of the inorganic particles as a measurement target may be obtained after analysis is performed using inductively coupled plasma (ICP) emission spectroscopy or an atomic absorption method.

Examples of the method of adhering inorganic particles to the coating layer include a method of stirring and mixing a carrier before adhesion of inorganic particles thereto and inorganic particles in a V blender (container-rotary type V-shaped mixer) and a method of stirring and mixing a carrier before adhesion of inorganic particles thereto and inorganic particles in a Henschel mixer.

—Characteristics of Carrier—

For example, the volume average particle diameter of the carrier is in the range of 20 μm to 200 μm, preferably in the range of 25 μm to 60 μm, and more preferably in the range of 25 μm to 40 μm.

Here, the volume average particle diameter of the carrier is measured as follows. Further, the volume average particle diameter of the core particles is measured in the same manner.

The particle size distribution is measured using a laser diffraction/scattering particle size distribution measuring apparatus (LS Particle Size Analyzer (manufactured by BECKMAN COULTER)). ISOTON-II (manufactured by BECKMAN COULTER) is used as an electrolyte. The number of particles to be measured is 50,000.

Further, in the measured particle size distribution, cumulative volume distribution is drawn from the small diameter side with respect to the divided particle size range (channel), and the particle size corresponding to 50% cumulation (also referred to as “D50v” in some cases) is defined as a “volume average particle diameter.”

In the magnetic force of the carrier, the saturation magnetization in a 1000 Oersted magnetic field may be 40 emu/g or more or 50 emu/g or more.

Here, measurement of saturation magnetization of the carrier is performed using a vibrating sample type magnetism measuring apparatus VSMP10-15 (manufactured by Toei Industry Co., Ltd.). A measurement sample is packed in a cell having an inner diameter of 7 mm and a height of 5 mm and is set on the apparatus. Measurement is performed by adding an applied magnetic field and sweeping the magnetic field to a maximum 3000 Oersted. Subsequently, a hysteresis curve is prepared on recording sheet by reducing the applied magnetic field. Saturation magnetization is obtained through data of the curve.

The volume electric resistance (25° C.) of the carrier may be in the range of 1×10⁷ Ω·cm to 1×10¹⁵ Ω·cm, preferably in the range of 1×10⁸ Ω·cm to 1×10¹⁴ Ω·cm, and more preferably in the range of 1×10⁸ Ω·cm to 1×10¹³ Ω·cm.

The volume electric resistance of the carrier is measured as follows. A target object to be measured is placed to be flat on a surface of a circular jig, on which an electrode plate having a size of 20 cm² is arranged, such that the thickness of the target object is set to be in the range of 1 mm to 3 mm, thereby forming a layer. The electrode plate having a size of 20 cm² is placed on the layer to interpose the layer. The thickness (cm) of the layer is measured after applying a 4 kg load to the electrode plate arranged on the layer for removing a void between target objects to be measured. Both electrodes on the upper side and on the lower side of the layer are connected to an electrometer and a high-voltage power source generator. A high voltage is applied to both electrodes such that an electric field strength is adjusted to 103.8 V/cm, and the current value (A) flowing at this time is read. The temperature and the humidity of the measurement environment are set to be 20° C. and 50% RH respectively. A calculation equation of the volume electric resistance (Ω·cm) of a target object to be measured is as follows.

R=E×20/(I−I₀)/L

In the equation above, R represents the volume electric resistance (Ω·cm) of a target object to be measured, E represents an applied voltage (V), I represents a current value (A), I₀ represents a current value (A) in an applied voltage 0 V, and L represents the thickness (cm) of a layer. A coefficient 20 represents the area (cm²) of an electrode plate.

Electrostatic Charge Image Developer

The electrostatic charge image developer (hereinafter, referred to as a developer) according to the present exemplary embodiment includes a toner for developing an electrostatic charge image (hereinafter, referred to as a “toner”) and the carrier according to the present exemplary embodiment.

Hereinafter, a toner will be described.

The toner includes toner particles. The toner may contain an external additive if necessary.

Toner Particles

The toner particles contain, for example, a binder resin. The toner particles may contain a coloring agent, a release agent, and other additives if necessary.

Binder Resin

Examples of the binder resin include a vinyl resin formed of a homopolymer of monomers such as styrenes (for example, styrene, parachlorostyrene, and α-methylstyrene); (meth)acrylic acid esters (for example, methyl acrylate, and ethyl acrylate, n-propyl acrylate, n-butyl acrylate, lauryl acrylate, 2-ethylhexyl acrylate, methyl methacrylate, ethyl methacrylate, n-propyl methacrylate, laurylmethacrylate, and 2-ethylhexyl methacrylate); ethylenically unsaturated nitriles (for example, acrylonitrile and methacrylonitrile); vinyl ethers (for example, vinyl methyl ether and vinyl isobutyl ether); vinyl ketones (vinyl methyl ketone, vinyl ethyl ketone, and vinyl isopropenyl ketone); and olefins (for example, ethylene, propylene, and butadiene) or a copolymer combining two or more kinds of these monomers.

Examples of the binder resin include a non-vinyl resin such as an epoxy resin, a polyester resin, a polyurethane resin, a polyamide resin, a cellulose resin, a polyether resin, or a modified rosin; a mixture of these and the vinyl resin; and a graft polymer obtained by polymerizing vinyl monomers in the coexistence of these.

These binder resins may be used alone or in combination of two or more kinds thereof.

The content of the binder resin is preferably in the range of 40% by weight to 95% by weight, more preferably in the range of 50% by weight to 90% by weight, and still more preferably in the range of 60% by weight to 85% by weight with respect to the entire toner particles.

—Colorants—

Examples of colorants include various pigments such as Carbon Black, Chrome Yellow, Hansa Yellow, Benzidine Yellow, Threne Yellow, Quinoline Yellow, Pigment Yellow, Permanent Orange GTR, Pyrazolone Orange, Vulcan Orange, Watchung Red, Permanent Red, Brilliant Carmine 3B, Brilliant Carmine 6B, Du Pont Oil Red, Pyrazolone Red, Lithol Red, Rhodamine B Lake, Lake Red C, Pigment Red, Rose Bengal, Aniline Blue, Ultramarine Blue, Calco Oil Blue, Methylene Blue Chloride, Phthalocyanine Blue, Pigment Blue, Phthalocyanine Green, and Malachite Green Oxalate; and various dyes such as an acridine dye, a xanthene dye, an azo dye, a benzoquinone dye, an azine dye, an anthraquinone dye, a thioindigo dye, a dioxazine dye, a thiazine dye, an azomethine dye, an indigo dye, a phthalocyanine dye, an aniline black dye, a polymethine dye, a triphenylmethane dye, a diphenylmethane dye, and a thiazole dye.

These colorants may be used alone or in combination of two or more kinds thereof.

As the colorant, a colorant subjected to a surface treatment may be used according to the necessity or a combination with a dispersant may be used. In addition, the colorants may be used in combination of plural kinds thereof.

The content of the colorant is preferably in the range of 1% by weight to 30% by weight and more preferably in the range of 3% by weight to 15% by weight with respect to the entire toner particles.

—Release Agent—

Examples of the release agent include a hydrocarbon wax, natural waxes such as a carnauba wax, a rice wax, and a candelilla wax; synthetic or mineral and petroleum waxes such as a montan wax; and ester waxes such as fatty acid ester and montan acid ester. However, the release agents are not limited to these examples.

The melting temperature of the release agent is preferably in the range of 50° C. to 110° C. and more preferably in the range of 60° C. to 100° C.

Further, the melting temperature is obtained from a “melting peak temperature” described in a method of acquiring the melting temperature in JIS K-1987 “Testing methods for Transition Temperatures of Plastics” based on a DSC curve obtained using differential scanning calorimetry (DSC).

The content of the release agent is preferably in the range of 1% by weight to 20% by weight and more preferably in the range of 5% by weight to 15% by weight with respect to the entire toner particles.

—Other Additives—

Examples of other additives include known additives such as a magnetic material, a charge-controlling agent, and inorganic powders. These additives are contained in toner particles as internal additives.

—Characteristics of Toner Particles—

The toner particles may have a single layer structure or a so-called core-shell structure formed of a core (core particles) and a coating layer (shell layer) covering the core.

Here, the toner particles having a core-shell structure may preferably be formed of a core containing a binder resin and other additives such as a coloring agent and a release agent according to the necessity; and a coating layer containing a binder resin.

The volume average particle diameter (D50v) of the toner particles is preferably in the range of 2 μm to 10 μm and more preferably in the range of 4 μm to 8 μm.

In addition, various average particle diameters and various particle size distribution indices of toner particles are measured using Coulter Multisizer-II (manufactured by BECKMAN COULTER) and using ISOTON-II (manufactured by BECKMAN COULTER) as an electrolyte solution.

During the measurement, a measurement sample is added to 2 mL of a 5% aqueous solution of a surfactant (sodium alkylbenzene sulfonate is preferable) as a dispersant by an amount of 0.5 mg to 50 mg. The solution is added to 100 mL to 150 mL of an electrolyte solution.

The electrolyte in which the sample is suspended is subjected to a dispersion treatment in an ultrasonic disperser for 1 minute, and the particle size distribution of particles having a particle diameter in the range of 2 μm to 60 μm is measured using an aperture having an aperture diameter of 100 μm with Coulter Multisizer-II. Further, the number of particles for sampling is 50000.

Cumulative distributions of the volume and the number are drawn from the small diameter side with respect to the particle size range (channel) divided based on the measured particle size distribution, and the particle diameter corresponding to 16% cumulation is defined as a volume particle diameter D16v and a number particle diameter D16p, the particle diameter corresponding to 50% cumulation is defined as a volume average particle diameter D50v and a number average particle diameter D50p, and the particle diameter corresponding to 84% cumulation is defined as a volume particle diameter D84v and a number particle diameter D84p.

Using these definitions, the volume average particle size distribution index (GSDv) is calculated as (D84v/D16v)^{1/2} and the number average particle size distribution index (GSDp) is calculated as (D84p/D16p)^{1/2}

A shape factor SF1 of the toner particles is preferably in the range of 110 to 150 and more preferably in the range of 120 to 140.

In addition, the shape factor SF1 is obtained by the following equation.

SF1=(ML²/A)×(π/4)×100 Equation

In the equation, ML represents a maximum absolute length of a toner and A represents a projected area of a toner.

Specifically, the shape factor SF1 is digitized by mainly analyzing a microscope image or a scanning electron microscope (SEM) image using an image analyzer and is calculated as follows. That is, an optical microscope image of particles sprayed on the surface of slide glass is captured in an image analyzer (Luzex) by a video camera, the maximum length and the projected area of one hundred particles are obtained, and calculation is performed using the above equation, and then the average value thereof is obtained, thereby obtaining the shape factor.

External Additives

As the external additive, inorganic particles are exemplified. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)n, Al₂O₃.2SiO₂, CaCO₃, MgCO₃, BaSO₄, and MgSO₄.

The surface of inorganic particles as an external additive may be subjected to a hydrophobizing treatment. The hydrophobizing treatment is performed by dipping the inorganic particles in a hydrophobizing agent. The hydrophobizing agent is not particularly limited, and examples thereof include a si lane coupling agent, silicone oil, a titanate coupling agent, and an aluminum coupling agent. These may be used alone or in combination of two or more kinds thereof.

The amount of the hydrophobizing agent is generally in the range of 1 part by weight to 10 parts by weight with respect to 100 parts by weight of the inorganic particles.

Examples of the external additive include resin particles (resin particles such as polystyrene, PMMA, and a melamine resin) and cleaning aids (metal salts of higher fatty acids represented by zinc stearate and particles of a fluorine-based polymer).

The amount of the external additive externally added is preferably in the range of 0.01% by weight to 5% by weight and more preferably in the range of 0.01% by weight to 2.0% by weight with respect to toner particles.

Method of Preparing Toner

Next, a method of preparing a toner according to the present exemplary embodiment will be described.

The toner according to the present exemplary embodiment may be obtained by externally adding an external additive to toner particles after the toner particles are prepared.

The toner particles may be prepared using a dry method (for example, a kneading and pulverizing method) or a wet method (for example, an aggregation and coalescence method, a suspension polymerization method, or a dissolution suspension method). The method of preparing toner particles is not particularly limited, and a known method is employed.

Among these, the toner particles may preferably be obtained using an aggregation and coalescence method.

Further, a toner is prepared by adding an external additive to the obtained toner particles in a dry state and performing mixing. The mixing may preferably be performed using a V blender, a Henschel mixer, or a Lödige mixer. Further, coarse particles of the toner may be removed using a vibration sieve or a wind classifier if necessary.

In addition, a mixing ratio (weight ratio) of the toner to the carrier in a two-component developer is preferably in the range of 1:100 to 30:100 and more preferably in the range of 3:100 to 20:100 (toner:carrier).

Image Forming Apparatus/Image Forming Method

An image forming apparatus and an image forming method according to the present exemplary embodiment will be described.

The image forming apparatus according to the present exemplary embodiment includes an image holding member; a charging unit that charges a surface of the image holding member; an electrostatic charge image forming unit that forms an electrostatic charge image on the surface of a charged image holding member; a developing unit that accommodates an electrostatic charge image developer and develops the electrostatic charge image formed on the surface of the image holding member as a toner image using the electrostatic charge image developer; a transfer unit that transfers the toner image formed on the surface of the image holding member to the surface of a recording medium; and a fixing unit that fixes the toner image transferred to the surface of the recording medium. In addition, the electrostatic charge image developer according to the present exemplary embodiment is applied as an electrostatic charge image developer.

In the image forming apparatus according to the present exemplary embodiment, an image forming method (image forming method according to the present exemplary embodiment) including a charging process of charging a surface of an image holding member; an electrostatic charge image forming process of forming an electrostatic charge image on the surface of a charged image holding member; a developing process of developing the electrostatic charge image formed on the surface of the image holding member as a toner image using the electrostatic charge image developer according to the present exemplary embodiment; a transfer process of transferring the toner image formed on the surface of the image holding member to the surface of a recording medium; and a fixing process of fixing the toner image transferred to the surface of the recording medium, is performed.

Examples of the image forming apparatus according to the present exemplary embodiment include known image forming apparatuses such as an apparatus having a direct transfer system of directly transferring a toner image formed on a surface of an image holding member to a recording medium; an apparatus having an intermediate transfer system of primarily transferring a toner image formed on a surface of an image holding member to a surface of an intermediate transfer member and then secondarily transferring the toner image transferred to the surface of the intermediate transfer member to a surface of a recording medium; an apparatus including a cleaning unit that performs cleaning of a surface of an image holding member after transferring a toner image and before charging; and an apparatus including an erasing unit that erases a surface of an image holding member by irradiation with erasing light after transferring a toner image and before charging.

In the case of the apparatus having an intermediate transfer system, the transfer unit has a configuration including an intermediate transfer member to a surface of which a toner image is transferred; a primary transfer unit that primarily transfers the toner image formed on a surface of an image holding member to the surface of the intermediate transfer member; and a secondary transfer unit that secondarily transfers the toner image transferred to the surface of the intermediate transfer member to the surface of the recording medium.

In addition, in the image forming apparatus according to the present exemplary embodiment, a portion including the developing unit may have a cartridge structure (process cartridge) which is detachable from the image forming apparatus. As the process cartridge, a process cartridge accommodating the electrostatic charge image developer according to the present exemplary embodiment and including the developing unit is preferably used.

Hereinafter, an example of the image forming apparatus according to the present exemplary embodiment will be described, but the present invention is not limited thereto. In addition, main elements illustrated in the figures are described and description of other elements is omitted.

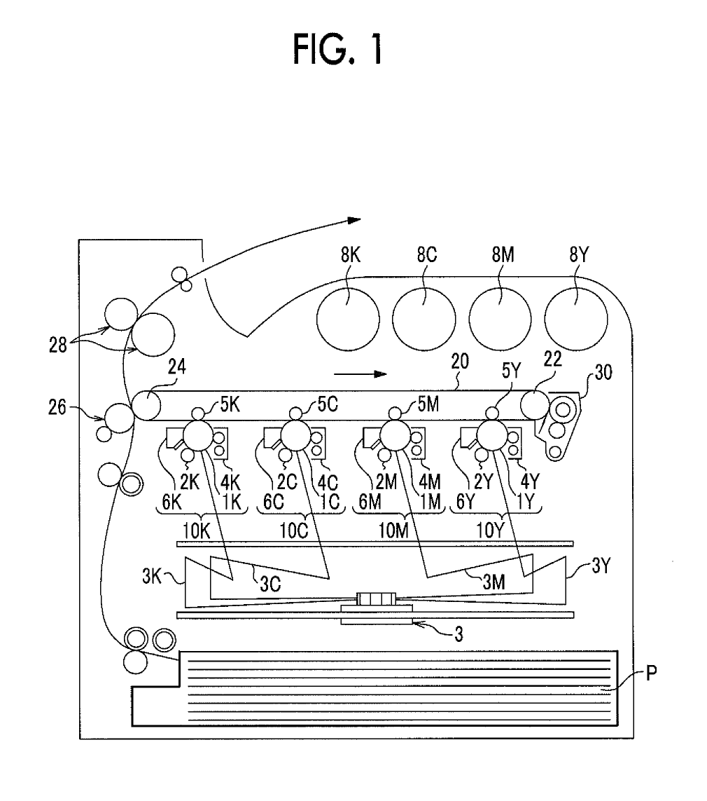

FIG. 1 is a view schematically illustrating the configuration of the image forming apparatus according to the present exemplary embodiment.

The image forming apparatus illustrated in FIG. 1 includes first to fourth image forming units 10Y, 10M, 10C, and 10K (image forming units) having an electrophotographic system of outputting images of respective colors of yellow (Y), magenta (M), cyan (C), and black (K) based on color-separated image data. These image forming units (hereinafter, simply referred to as “units” in some cases) 10Y, 10M, 10C, and 10K are disposed in parallel in a state of being separated from one another by a predetermined distance in the horizontal direction. Further, these units 10Y, 10M, 10C, and 10K may be process cartridges that are detachable from the image forming apparatus.

On the upper side in the figure of respective units 10Y, 10M, 10C, and 10K, an intermediate transfer belt 20 as an intermediate transfer member is extended through the respective units. The intermediate transfer belt 20 is provided in a state of being wound around a driving roll 22 and a support roll 24 in contact with the inner surface of the intermediate transfer belt 20, which are arranged by being separated from each other in the left to right direction in the figure, and travels toward the fourth unit 10K from the first unit 10Y. Moreover, to the support roll 24, a force is applied in a direction away from the driving roll 22 due to a spring or the like (not illustrated) and tension is applied to the intermediate transfer belt 20 wound around the support roll and the driving roll. Further, an intermediate transfer member cleaning apparatus 30 is provided on the surface of the image holding member side of the intermediate transfer belt 20 so as to face the driving roll 22.

In addition, toners including four color toners, yellow, magenta, cyan, and black accommodated in toner cartridges 8Y, 8M, 8C, and 8K are supplied to respective developing devices (developing units) 4Y, 4M, 4C, and 4K of the respective units 10Y, 10M, 10C, and 10K.

Since the first to fourth units 10Y, 10M, 10C, and 10K have the same configuration, the first unit 10Y which is disposed on the upstream side in a travelling direction of the intermediate transfer belt and forms a yellow image will be described as a representative example. In addition, the description of the second to fourth units 10M, 10C, and 10K is omitted by denoting the reference numeral of magenta (M), cyan (C), or black (K) to a part equivalent to the first unit 10Y instead of yellow (Y).

The first unit 10Y includes a photoreceptor 1Y acting as an image holding member. A charging roll (an example of a charging unit) 2Y that charges the surface of the photoreceptor 1Y to a predetermined potential; an exposure device (an example of an electrostatic charge image forming unit) 3 that forms an electrostatic charge image by exposing the charged surface with laser light 3Y based on a color-separated image signal; a developing device (an example of a developing unit) 4Y that develops the electrostatic charge image by supplying a charged toner to the electrostatic charge image; a primary transfer roll 5Y (an example of a primary transfer unit) that transfers a developed toner image onto the intermediate transfer belt 20; and a photoreceptor cleaning device (an example of a cleaning unit) that removes a toner remaining on the surface of the photoreceptor 1Y after the primary transfer are arranged around the photoreceptor 1 in this order.

In addition, the primary transfer roll 5Y is arranged inside the intermediate transfer belt 20 and provided in a position facing the photoreceptor 1. Further, bias power sources (not illustrated) applying primary transfer bias are respectively connected to each of the primary transfer rolls 5Y, 5M, 5C, and 5K. The respective bias power sources change the transfer bias applied to the respective primary transfer rolls through control of a control unit (not illustrated).

Hereinafter, an operation of forming a yellow image in the first unit 10Y will be described.

First, prior to the operation, the surface of the photoreceptor 1Y is charged to a potential of −600 V to −800 V by the charging roll 2Y.

The photoreceptor 1Y is formed by laminating a photosensitive layer on a conductive (for example, volume resistivity at 20° C.: 1×10⁻⁶ Ω·cm or less) substrate. The photosensitive layer has high resistance (resistant of a general resin) in general, but the photosensitive layer has a property in which specific resistance of a portion irradiated with laser light is changed when the portion is irradiated with laser light 3Y. For this reason, the laser light 3Y is output to the surface of the charged photoreceptor 1Y through the exposure device 3 according to image data for yellow transmitted from the control unit (not illustrated). The photosensitive layer on the surface of the photoreceptor 1Y is irradiated with the laser light 3Y, and accordingly, an electrostatic charge image of a yellow image pattern is formed on the surface of the photoreceptor 1Y.

The electrostatic charge image is an image formed on the surface of the photoreceptor 1Y through charging and is a so-called negative latent image formed when the specific resistance on the irradiated portion of the photosensitive layer is decreased by the laser light 3Y, the charge on the surface of the photoreceptor 1Y flows, and the charge of the portion not irradiated with the laser light 3Y remains.

The electrostatic charge image formed on the photoreceptor 1Y is rotated to a predetermined developing position according to travelling of the photoreceptor 1Y. In addition, the electrostatic charge image on the photoreceptor 1Y is made into a visible image (developed image) as a toner image by the developing device 4Y in the developing position.

For example, an electrostatic charge image developer including at least a yellow toner and a carrier is accommodated in the developing device 4Y. The yellow toner is frictionally charged by being stirred in the developing device 4Y and is held on a developer roll (an example of a developer holding member) with a charge of the same polarity (negative polarity) as the charge on the photoreceptor 1Y. Further, when the surface of the photoreceptor 1Y passes through the developing device 4Y, the yellow toner is electrostatically adhered to an erased latent image portion on the surface of the photoreceptor 1Y and a latent image is developed by the yellow toner. The photoreceptor 1Y on which a yellow toner image is formed continuously travels at a predetermined speed and the toner image developed on the photoreceptor 1Y is transported to a predetermined primary transfer position.

When the yellow toner image on the photoreceptor 1Y is transported to the primary transfer position, primary transfer bias is applied to the primary transfer roll 5Y, the electrostatic force toward the primary transfer roll 5Y from the photoreceptor 1Y acts on the toner image, and the toner image on the photoreceptor 1Y is transferred onto the intermediate transfer belt 20. The transfer bias to be applied at this time is a positive (+) polarity which is an opposite polarity of the toner polarity (−) and is controlled to be +10 μA by a control unit (not illustrated) in the first unit 10Y, for example.

In addition, a toner remaining on the photoreceptor 1Y is removed by the photoreceptor cleaning device 6Y to be collected.

In addition, the primary transfer bias to be applied to primary transfer rolls 5M, 5C, and 5K of the second unit 10M and the subsequent units is controlled in a manner similar to that of the first unit.

In this manner, the intermediate transfer belt 20 to which a yellow toner image is transferred in the first unit 10Y is sequentially transported through the second to fourth units 10M, 10C, and 10K, and toner images of respective colors are multiply transferred in a superimposed manner.

The intermediate transfer belt 20 to which four colors of toner images are multiply transferred through the first to fourth units reaches the secondary transfer portion formed of the intermediate transfer belt 20, the support roll 24 in contact with the inner surface of the intermediate transfer belt, and a secondary transfer roll (an example of a secondary transfer unit) 26 arranged on the image holding surface side of the intermediate transfer belt 20. On the other hand, the recording sheet (an example of a recording medium) P is fed to a void between the secondary transfer roll 26 and the intermediate transfer belt 20 in contact with each other through a supply mechanism at a predetermined timing, and the secondary transfer bias is applied to the support roll 24. The transfer bias to be applied at this time is the negative (−) polarity which is the same as the polarity (−) of a toner, the electrostatic force toward the recording sheet P from the intermediate transfer belt 20 acts on the toner image, and the toner image on the intermediate transfer belt 20 is transferred onto the recording sheet P. Further, the secondary transfer bias at this time is determined according to the resistance detected by a resistance detecting unit (not illustrated) that detects the resistance of the secondary transfer portion and the voltage thereof is controlled.

Next, the recording sheet P is sent to a pressure contact portion (nip portion) of a pair of fixing rolls in a fixing device (an example of a fixing unit) 28, the toner image is fixed onto the recording sheet P, and a fixed image is formed.

As the recording sheet P to which a toner image is transferred, plain paper used in a copying machine or a printer having an electrophotographic system may be exemplified. As the recording medium, an OHP sheet may be exemplified in addition to the recording sheet P.

In order to further improve smoothness of the surface of the fixed image, the surface of the recording sheet P is also preferably smooth, and, for example, coated paper obtained by coating the surface of plain paper with a resin or the like or art paper for printing is preferably used.

The recording sheet P in which fixation of a color image is completed is discharged toward a discharge unit and a series of color image forming operations is terminated.

Process Cartridge/Developer Cartridge

A process cartridge according to the present exemplary embodiment will be described.

The process cartridge according to the present exemplary embodiment is a process cartridge that includes a developing unit accommodating the electrostatic charge image developer according to the present exemplary embodiment, and developing an electrostatic charge image formed on the surface of the image holding member as a toner image by the electrostatic charge image developer, and is detachable from the image forming apparatus.

In addition, the process cartridge according to the present exemplary embodiment may have a configuration, which is not limited to the above-described configuration, including a developing device and at least one unit selected from other units such as an image holding member, a charging unit, an electrostatic charge image forming unit, and a transfer unit according to the necessity.

Hereinafter, an example of the process cartridge according to the present exemplary embodiment will be described, but the present invention is not limited thereto. In addition, main elements illustrated in the figures are described and description of other elements is omitted.

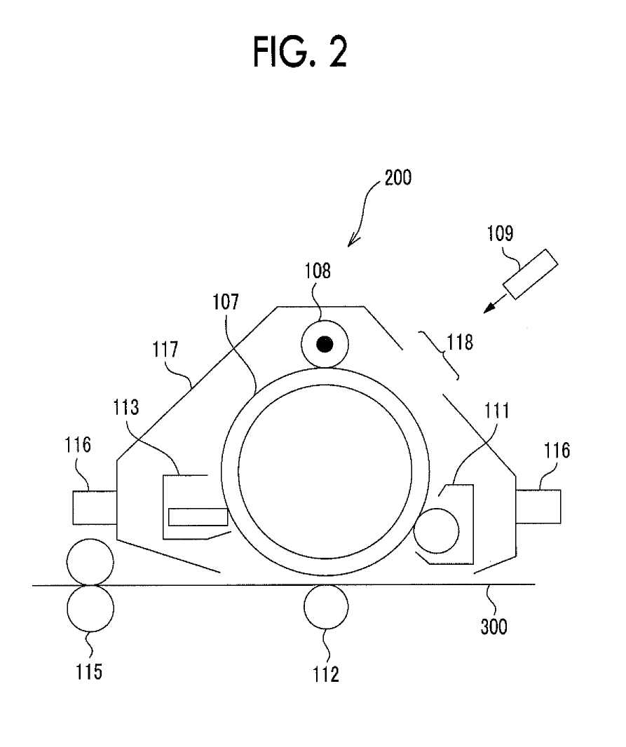

FIG. 2 is a view schematically illustrating the configuration of the process cartridge according to the present exemplary embodiment.

A process cartridge 200 illustrated in FIG. 2 is configured by integrally combining and holding a photoreceptor 107 (an example of an image holding member), a charging roll 108 (an example of a charging unit), a developing device 111 (an example of a developing unit), and a photoreceptor cleaning device 113 (an example of a cleaning unit) which are provided around the photoreceptor 107 by a housing 117 including a mounting rail 116 and an opening portion 118 for exposure, and made into a cartridge.

Further, in FIG. 2, the reference numeral 109 indicates an exposure device (an example of an electrostatic charge image forming unit), the reference numeral 112 indicates a transfer device (an example of a transfer unit), the reference numeral 115 indicates a fixing device (an example of a fixing unit), and the reference numeral 300 indicates recording sheet (an example of a recording medium).

Next, a developer cartridge according to the present exemplary embodiment will be described.

The developer cartridge according to the present exemplary embodiment is a developer cartridge that accommodates the developer according to the present exemplary embodiment and is detachable from the image forming apparatus.

For example, in the image forming apparatus illustrated in FIG. 1, toner cartridges 8Y, 8M, 8C, and 8K may be developer cartridges according to the present exemplary embodiment. In a case where developers accommodated in the cartridges run short, the cartridge is replaced.

### EXAMPLES

Hereinafter, the present exemplary embodiment will be described in detail based on Examples and Comparative Examples, but the present exemplary embodiment is not limited to the following Examples. Further, “part” and “%” described below are on a weight basis unless otherwise noted.

### Example 1

Preparation of Carrier 1

Ferrite particles (Mn—Mg ferrite, volume average particle diameter of 35 pin): 100 parts

Toluene: 15 parts

Styrene/methyl methacrylate copolymer (glass transition temperature of 71° C., weight average molecular weight of 92000): 2.5 parts

Resin particles (melamine resin particles, volume average particle diameter of 100 nm): 0.25 parts

The above-described components other than ferrite particles are dispersed using a homomixer for 3 minutes, a coating layer-forming solution is prepared, and the solution and ferrite particles are stirred for 15 minutes in a vacuum degassing kneader whose temperature is maintained at 60° C., and then the pressure is reduced to 5 kPa for 15 minutes to distill toluene, and a carrier substance having a coating layer formed thereon is obtained.

Subsequently, 100 parts of the obtained carrier substance and 0.06 parts of SiO₂ particles (sample manufactured by CABOT Corporation, SiO₂ particles, average particle diameter of 230 nm) are mixed (20 rpm/30 min) in a V blender, and the SiO₂ particles are adhered to the surface of the carrier substance, thereby obtaining a carrier 1.

The volume average particle diameter of the inorganic particles adhered to the surface of the coating layer of the obtained carrier 1 is 230 nm and the adhesion amount of the inorganic particles is 0.05% by weight.

### Example 2

### Preparation of Carrier 2

Ferrite particles (Mn—Mg ferrite, volume average particle diameter of 35 μm): 100 parts

Toluene: 15 parts

Styrene/methyl methacrylate copolymer (glass transition temperature of 71° C., weight average molecular weight of 92000): 2.5 parts

Resin particles (melamine resin particles, volume average particle diameter of 100 nm): 0.25 parts

The above-described components other than ferrite particles are dispersed using a homomixer for 3 minutes, a coating layer-forming solution is prepared, and the solution and ferrite particles are stirred for 15 minutes in a vacuum degassing kneader whose temperature is maintained at 60° C., and then a carrier substance that forms a coating layer by reducing the pressure to 5 kPa for 15 minutes and distilling toluene is obtained.

Subsequently, 100 parts of the obtained carrier substance and 0.06 parts of SiO₂ particles (sample manufactured by CABOT Corporation, SiO₂ particles, volume average particle diameter of 150 nm) are mixed (20 rpm/30 min) in a V blender, and the SiO₂ particles are adhered to the surface of the carrier substance, thereby obtaining a carrier 2.

The volume average particle diameter of the inorganic particles adhered to the surface of the coating layer of the obtained carrier 2 is 150 nm and the adhesion amount of the inorganic particles is 0.05% by weight.

### Example 3

### Preparation of Carrier 3

Ferrite particles (Mn—Mg ferrite, volume average particle diameter of 35 μm): 100 parts

Toluene: 15 parts

Styrene/methyl methacrylate copolymer (glass transition temperature of 71° C., weight average molecular weight of 92000): 2.5 parts

Resin particles (melamine resin particles, volume average particle diameter of 100 nm): 0.25 parts

The above-described components other than ferrite particles are dispersed using a homomixer for 3 minutes, a coating layer-forming solution is prepared, and the solution and ferrite particles are stirred for 15 minutes in a vacuum degassing kneader whose temperature is maintained at 60° C., and then a carrier substance that forms a coating layer by reducing the pressure to 5 kPa for 15 minutes and distilling toluene is obtained.

Subsequently, 100 parts of the obtained carrier substance and 0.06 parts of SiO₂ particles (sample manufactured by CABOT Corporation, SiO₂ particles, volume average particle diameter of 300 nm) are mixed (20 rpm/30 min) in a V blender, and the SiO₂ particles are adhered to the surface of the carrier substance, thereby obtaining a carrier 3.

The volume average particle diameter of the inorganic particles adhered to the surface of the coating layer of the obtained carrier 3 is 300 nm and the adhesion amount of the inorganic particles is 0.05% by weight.

### Example 4

### Preparation of Carrier 4

Ferrite particles (Mn—Mg ferrite, volume average particle diameter of 35 μm): 100 parts

Toluene: 15 parts

Styrene/methyl methacrylate copolymer (glass transition temperature of 71° C., weight average molecular weight of 92000): 2.5 parts

Resin particles (melamine resin particles, volume average particle diameter of 100 nm): 0.25 parts

The above-described components other than ferrite particles are dispersed using a homomixer for 3 minutes, a coating layer-forming solution is prepared, and the solution and ferrite particles are stirred for 15 minutes in a vacuum degassing kneader whose temperature is maintained at 60° C., and then a carrier substance that forms a coating layer by reducing the pressure to 5 kPa for 15 minutes and distilling toluene is obtained.

Subsequently, 100 parts of the obtained carrier substance and 0.1 parts of SiO₂ particles (sample manufactured by CABOT Corporation, SiO₂ particles, volume average particle diameter of 230 nm) are mixed (20 rpm/30 min) in a V blender, and the SiO₂ particles are adhered to the surface of the carrier substance, thereby obtaining a carrier 4.

The volume average particle diameter of the inorganic particles adhered to the surface of the coating layer of the obtained carrier 4 is 230 nm and the adhesion amount of the inorganic particles is 0.09% by weight.

### Example 5

### Preparation of Carrier 5

Ferrite particles (Mn—Mg ferrite, volume average particle diameter of 35 μm): 100 parts

Toluene: 15 parts

Styrene/methyl methacrylate copolymer (glass transition temperature of 71° C., weight average molecular weight of 92000): 2.5 parts

Resin particles (melamine resin particles, volume average particle diameter of 100 nm): 0.25 parts

The above-described components other than ferrite particles are dispersed using a homomixer for 3 minutes, a coating layer-forming solution is prepared, and the solution and ferrite particles are stirred for 15 minutes in a vacuum degassing kneader whose temperature is maintained at 60° C., and then a carrier substance that forms a coating layer by reducing the pressure to 5 kPa for 15 minutes and distilling toluene is obtained.

Subsequently, 100 parts of the obtained carrier substance and 0.06 parts of SiO₂ particles (sample manufactured by CABOT Corporation, SiO₂ particles, volume average particle diameter of 490 nm) are mixed (20 rpm/30 min) in a V blender, and the SiO₂ particles are adhered to the surface of the carrier substance, thereby obtaining a carrier 5.

The volume average particle diameter of the inorganic particles adhered to the surface of the coating layer of the obtained carrier 5 is 490 nm and the adhesion amount of the inorganic particles is 0.05% by weight.

### Comparative Example 1

### Preparation of Carrier 6

Ferrite particles (Mn—Mg ferrite, volume average particle diameter of 35 μm): 100 parts

Toluene: 15 parts

Styrene/methyl methacrylate copolymer (glass transition temperature of 71° C., weight average molecular weight of 92000) 2.5 parts

Resin particles (melamine resin particles, volume average particle diameter of 100 nm): 0.25 parts

The above-described components other than ferrite particles are dispersed using a homomixer for 3 minutes, a coating layer-forming solution is prepared, and the solution and ferrite particles are stirred for 15 minutes in a vacuum degassing kneader whose temperature is maintained at 60° C., and then a carrier substance that forms a coating layer by reducing the pressure to 5 kPa for 15 minutes and distilling toluene is obtained.

Subsequently, 100 parts of the obtained carrier substance and 0.06 parts of SiO₂ particles (sample manufactured by Tokuyama Corporation, SiO₂ particles, volume average particle diameter of 120 nm) are mixed (20 rpm/30 min) in a V blender, and the SiO₂ particles are adhered to the surface of the carrier substance, thereby obtaining a carrier 6.

The volume average particle diameter of the inorganic particles adhered to the surface of the coating layer of the obtained carrier 6 is 120 nm and the adhesion amount of the inorganic particles is 0.05% by weight.

### Comparative Example 2

### Preparation of Carrier 7

Ferrite particles (Mn—Mg ferrite, volume average particle diameter of 35 μm): 100 parts

Toluene: 15 parts

Styrene/methyl methacrylate copolymer (glass transition temperature of 71° C., weight average molecular weight of 92000): 2.5 parts

Resin particles (melamine resin particles, volume average particle diameter of 100 nm): 0.25 parts

The above-described components other than ferrite particles are dispersed using a homomixer for 3 minutes, a coating layer-forming solution is prepared, and the solution and ferrite particles are stirred for 15 minutes in a vacuum degassing kneader whose temperature is maintained at 60° C., and then a carrier substance that forms a coating layer by reducing the pressure to 5 kPa for 15 minutes and distilling toluene is obtained.

Subsequently, 100 parts of the obtained carrier substance and 0.015 parts of SiO₂ particles (sample manufactured by CABOT Corporation, SiO₂ particles, volume average particle diameter of 230 nm) are mixed (20 rpm/30 min) in a V blender, and the SiO₂ particles are adhered to the surface of the carrier substance, thereby obtaining a carrier 7.

The volume average particle diameter of the inorganic particles adhered to the surface of the coating layer of the obtained carrier 7 is 230 nm and the adhesion amount of the inorganic particles is 0.01% by weight.

### Comparative Example 3

### Preparation of Carrier 8

Ferrite particles (Mn—Mg ferrite, volume average particle diameter of 35 μm) 100 parts

Toluene: 15 parts

Styrene/methyl methacrylate copolymer (glass transition temperature of 71° C., weight average molecular weight of 92000): 2.5 parts

Resin particles (melamine resin particles, volume average particle diameter of 100 nm): 0.25 parts

The above-described components other than ferrite particles are dispersed using a homomixer for 3 minutes, a coating layer-forming solution is prepared, and the solution and ferrite particles are stirred for 15 minutes in a vacuum degassing kneader whose temperature is maintained at 60° C., and then a carrier substance that forms a coating layer by reducing the pressure to 5 kPa for 15 minutes and distilling toluene is obtained.

Subsequently, 100 parts of the obtained carrier substance and 0.17 parts of SiO₂ particles (sample manufactured by CABOT Corporation, SiO₂ particles, volume average particle diameter of 230 nm) are mixed (20 rpm/30 min) in a V blender, and the SiO₂ particles are adhered to the surface of the carrier substance, thereby obtaining a carrier 8.

The volume average particle diameter of the inorganic particles adhered to the surface of the coating layer of the obtained carrier 8 is 230 nm and the adhesion amount of the inorganic particles is 0.15% by weight.

### Comparative Example 4

### Preparation of Carrier 9

Ferrite particles (Mn—Mg ferrite, volume average particle diameter of 35 μm): 100 parts

Toluene: 15 parts

Styrene/methyl methacrylate copolymer (glass transition temperature of 71° C., weight average molecular weight of 92000): 2.5 parts

Resin particles (melamine resin particles, volume average particle diameter of 100 nm): 0.25 parts

The above-described components other than ferrite particles are dispersed using a homomixer for 3 minutes, a coating layer-forming solution is prepared, and the solution and ferrite particles are stirred for 15 minutes in a vacuum degassing kneader whose temperature is maintained at 60° C., and then a carrier substance that forms a coating layer by reducing the pressure to 5 kPa for 15 minutes and distilling toluene is obtained.

Subsequently, 100 parts of the obtained carrier substance and 0.06 parts of SiO₂ particles (sample manufactured by Tokuyama Corporation, SiO₂ particles, volume average particle diameter of 510 nm) are mixed (20 rpm/30 min) in a V blender, and the SiO₂ particles are adhered to the surface of the carrier substance, thereby obtaining a carrier 9.

The volume average particle diameter of the inorganic particles adhered to the surface of the coating layer of the obtained carrier 9 is 510 nm and the adhesion amount of the inorganic particles is 0.05% by weight.

### Evaluation

### Preparation of Toner 1

—Preparation of Colorant Particle Dispersion 1—

Cyan pigment: copper phthalocyanine B15:3 (manufactured by Dainichiseika Color & Chemicals Mfg. Co., Ltd.): 50 parts

Anionic surfactant: Neogen SC (manufactured by Dai-ichi Kogyo Seiyaku Co., Ltd.): 5 parts

Ion exchange water: 200 parts

The above-described components are mixed, dispersed by ULTRA-TURRAX (manufactured by IRA, Inc.) for 5 minutes, and further dispersed by an ultrasonic bath for 10 minutes, thereby obtaining a colorant particle dispersion 1 having a 21% solid content. When the volume average particle diameter is measured using a particle size measuring instrument LA-700 (manufactured by Horiba Ltd.), the value is 160 nm.

—Preparation of Release Agent Particle Dispersion 1—

Paraffin wax: HNP-9 (manufactured by Nippon Seiro Co., Ltd.): 19 parts

Anionic surfactant: Neogen SC (manufactured by Dai-ichi Kogyo Seiyaku Co., Ltd.): 1 part

Ion exchange water: 80 parts

The above-described components are mixed in a heat-resistant container and stirred for 30 minutes after increasing the temperature therein to 90° C. Next, the melt from the bottom portion of the container is circulated to a Gaulin homogenizer, a circulation operation corresponding to three passes is performed under the condition of a pressure of 5 MPa, the pressure is increased to 35 MPa, and then the circulation operation corresponding to three passes is further performed. The temperature of an emulsified liquid obtained in this manner is cooled to lower than or equal to 40° C. in the heat-resistant container, thereby obtaining a release agent particle dispersion 1. When the volume average particle diameter is measured using a particle size measuring instrument LA-700 (manufactured by Horiba Ltd.), the value is 240 nm.

—Preparation of Resin Particle Dispersion 1—

—Oil Layer—

Styrene (manufactured by Wako Pure Chemical Industries, Ltd.): 30 parts

Acrylic acid n-butyl (manufactured by Wako Pure Chemical Industries, Ltd.): 10 parts

β-carboxyethyl acrylate (manufactured by Rhodia Nikka Ltd.): 1.3 parts

Dodecane thiol (manufactured by Wako Pure Chemical Industries, Ltd.): 0.4 parts

—Water Layer 1—

Ion exchange water: 17 parts

Anionic surfactant (DAWFAX2A1, manufactured by Dow Chemical Company): 0.4 parts

Water Layer 2—

Ion exchange water: 40 parts

Anionic surfactant (DAWFAX2A1, manufactured by Dow Chemical Company): 0.05 parts

Ammonium peroxodisulfate (manufactured by Wako Pure Chemical Industries, Ltd.): 0.4 parts

The components of the oil layer and the components of the water layer 1 are put into a flask and stirred and mixed with each other to be set as a monomer emulsified dispersion. The components of the water layer 2 are put into a reaction container, the inside of the container is substituted with nitrogen, and the reaction system is heated to 75° C. using an oil bath while stirring. The above-described monomer emulsified dispersion is slowly added dropwise to the reaction container for 3 hours, and emulsion polymerization is performed. Polymerization is further continued at 75° C. after dropwise addition and then terminated after 3 hours, thereby obtaining a resin particle dispersion 1.

—Preparation of Toner Particles—

Resin particle dispersion 1: 150 parts

Colorant particle dispersion 1: 30 parts

Release agent particle dispersion 1: 40 parts

polyaluminum chloride: 0.4 parts

The above-described components are mixed and dispersed using ULTRA-TURRAX (manufactured by IKA, Inc.) in a stainless steel flask, and heated to 48° C. while the components in the flask are stirred with an oil bath for heating. The mixture is hold at 48° C. for 80 minutes and 70 parts of the resin particle dispersion 1 is added thereto.

Next, the pH in the system is adjusted to 6.0 using an aqueous sodium hydroxide solution having a concentration of 0.5 mol/L, the stainless steel flask is sealed, a seal of a stirring shaft is magnetically sealed, the flask is heated to 97° C. while stirring is continued, and then the flask is held for 3 hours. After the reaction is terminated, the resultant is cooled at a cooling rate of 1° C./min and solid-liquid separation is performed by Nutsche suction filtration. The resultant is re-dispersed using 3,000 parts of ion exchange water at 40° C., stirred at 300 rpm for 15 minutes, and then washed. The washing operation is repeatedly performed 5 times and solid-liquid separation is performed by Nutsche suction filtration using filter paper No. 5A. Next, vacuum drying is continued for 12 hours and toner particles are obtained.

—External Addition of External Additive—

Silica (SiO₂) particles which are subjected to a surface hydrophobizing treatment using hexamethyldisilazane (hereinafter, referred to as “HMDS” in some cases) and of which an average particle diameter of primary particles is 40 nm and metatitanic acid compound particles which are products obtained by reacting metatitanic acid and isobutyltrimethoxysilane and of which an average particle diameter of primary particles is 20 nm are added to the toner particles such that the coverage with respect to the surface of the toner particles becomes 40%, and the mixture is mixed with a Henschel mixer, thereby preparing a toner 1.

Preparation of Developer and Evaluation of Image Quality

8 parts of the toner 1 is mixed with respectively 100 parts of carriers 1 to 9 prepared in the respective examples, and respective developers are prepared. An output test is performed by a modified machine of DocuCentre Color 400 (manufactured by Fuji Xerox Co., Ltd.) using these developers. 10000 sheets in total of human figure chart images are continuously output to plain paper in an environment of a high temperature and high humidity (environment of 24° C. and 55% RH), chart images are output, and then evaluation of the thin line reproducibility is visually performed.

A case where defects of images in regard to thin line reproducibility are visually confirmed is evaluated as C (x), a case where defects thereof are barely visually confirmed is evaluated as B (Δ), and a case where defects thereof are not visually confirmed is evaluated as A (O). The obtained results are listed in Table 1.

TABLE 1

| | Carrier | | | Evaluation of |
|---|---|---|---|---|
| | | Volume aver- | Adhesion | image quality |
| | | age particle | amount (% | (thin line |
| | No. | diameter (nm) | by weight) | reproducibility) |
| Example 1 | 1 | 230 nm | 0.05% by weight | A(◯) |
| Example 2 | 2 | 150 nm | 0.05% by weight | A(◯) |
| Example 3 | 3 | 300 nm | 0.05% by weight | A(◯) |
| Example 4 | 4 | 230 nm | 0.09% by weight | A(◯) |
| Example 5 | 5 | 490 nm | 0.05% by weight | B(Δ) |
| Comparative | 6 | 120 nm | 0.05% by weight | C(X) |
| Example 1 | | | | |
| Comparative | 7 | 230 nm | 0.01% by weight | C(X) |
| Example 2 | | | | |
| Comparative | 8 | 230 nm | 0.15% by weight | C(X) |
| Example 3 | | | | |
| Comparative | 9 | 510 nm | 0.05% by weight | C(X) |
| Example 4 | | | | |

From the above-described results, it is understood that excellent results may be obtained, in Examples, in regard to the evaluation of image quality of thin line reproducibility compared to Comparative Examples.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic charge image developing carrier, comprising:
core particles;
a coating layer that covers the core particles; and
inorganic particles that are adhered to the surface of the coating layer, wherein the inorganic particles have a volume average particle diameter in a range of 150 nm to 500 nm, and an adhesion amount in a range of 0.02% by weight to 0.1% by weight with respect to the entire carrier.

2. The electrostatic charge image developing carrier according to claim 1, wherein the core particles are ferrite particles.

3. The electrostatic charge image developing carrier according to claim 2, wherein the ferrite particles are represented by the following formula:
(MO)_{X}(Fe₂O₃)_{Y}
wherein Y is in a range of 2.1 to 2.4, X represents 3−Y, and M represents a metallic element.

4. The electrostatic charge image developing carrier according to claim 3, wherein the metallic element contains Mn.

5. The electrostatic charge image developing carrier according to claim 3, wherein the metallic element contains at least one kind selected from the group consisting of Li, Ca, Sr, Sn, Cu, Zn, Ba, Mg, and Ti.

6. The electrostatic charge image developing carrier according to claim 1, wherein a volume average particle diameter of the core particles is in a range of 10 μm to 500 μm.

7. The electrostatic charge image developing carrier according to claim 1, wherein the inorganic particles are silica particles.

8. The electrostatic charge image developing carrier according to claim 1, wherein the volume average particle diameter of the inorganic particles is in a range of 200 nm to 400 nm.

9. The electrostatic charge image developing carrier according to claim 1, wherein the coating layer contains conductive particles.

10. The electrostatic charge image developing carrier according to claim 9, wherein the conductive particles contain at least one kind selected from the group consisting of carbon black, metal powder, titanium oxide, tin oxide, magnetite, and ferrite.

11. The electrostatic charge image developing carrier according to claim 9,
wherein the conductive particles are carbon black, and
a DSP oil absorption amount of the carbon black is in a range of 50 mL/100 g to 250 mL/100 g.

12. The electrostatic charge image developing carrier according to claim 1, wherein the coating amount of the coating layer with respect to the core particles is 0.5% by weight or more with respect to the total weight of the carrier.

13. The electrostatic charge image developing carrier according to claim 1, wherein the carrier has a volume average particle diameter in a range of 20 μm to 200 μm.

14. The electrostatic charge image developing carrier according to claim 1, wherein, in the magnetic force of the carrier, the saturation magnetization in a 1000 Oersted magnetic field is 40 emu/g or more.

15. The electrostatic charge image developing carrier according to claim 1, wherein a volume electric resistance at 25° C. is in a range of 1×10⁷ Ω·cm to 1×10¹⁵ Ω·cm.

16. An electrostatic charge image developer comprising:
a toner for developing an electrostatic charge image; and
the electrostatic charge image developing carrier according to claim 1.

17. The electrostatic charge image developer according to claim 16, wherein the toner has a core-shell structure.

18. The electrostatic charge image developer according to claim 16, wherein a shape factor SF1 of the toner is in a range of 110 to 150.

19. A developer cartridge that accommodates the electrostatic charge image developer according to claim 16 and is detachable from an image forming apparatus.
